(19) United States
(12) Patent Application Publication
(10) Pub. No.: US 2024/0112848 A1
(43) Pub. Date: Apr. 4, 2024

(54) PACKAGE STRUCTURE

(71) Applicant: Advanced Semiconductor Engineering, Inc., Kaohsiung (TW)

(72) Inventors: Wu Chou HSU, Kaohsiung (TW); Hung Yi CHUANG, Kaohsiung (TW)

(73) Assignee: Advanced Semiconductor Engineering, Inc., Kaohsiung (TW)

(21) Appl. No.: 17/956,681

(22) Filed: Sep. 29, 2022

(51) Int. Cl. H01F 27/28; H01F 27/24

(52) U.S. Cl. CPC H01F 27/2823; H01F 27/24

(57) ABSTRACT

A package structure is provided. The package structure includes an electronic component and a connection element. The electronic component includes a conductive wire and a magnetic layer encapsulating the conductive wire. The connection element penetrates and contacts the magnetic layer and the conductive wire.

### BACKGROUND

### 1. Technical Field

The present disclosure relates generally to a package structure.

### 2. Description of the Related Art

As multi-functionality and high performance have become typical requirements of consumer electronic and communication products such as smart phones, electronic device packages are expected to possess superior electrical properties, low power consumption, and a large number of I/O ports. In order to achieve multi-functionality and improved performance, the packages are equipped with more components, both active and passive. Such components, however, tend to increase overall thickness of the package. It is therefore desirable to develop a package substrate with reduced thickness, multi-functionality, improved performance, and lower power consumption, while meeting the requirement for minimized profile for consumer electronic and communication devices.

### SUMMARY

In one or more embodiments, a package structure includes an electronic component and a connection element. The electronic component includes a conductive wire and a magnetic layer encapsulating the conductive wire. The connection element penetrates and contacts the magnetic layer and the conductive wire.

In one or more embodiments, a package structure includes an electronic component and a conductive gel. The electronic component includes a magnetic body and a conductive wire embedded in the magnetic body. The conductive gel penetrates the magnetic body and contacts the conductive wire.

In one or more embodiments, a package structure includes an inductor, a first connection element, and a first conductive via. The inductor includes a conductive wire. The first connection element penetrates the inductor and contacts the conductive wire. The first conductive via is electrically connected to the first connection element, wherein a contact interface between the first conductive via and the first connection element substantially aligns with a first surface of the inductor.

### BRIEF DESCRIPTION OF THE DRAWINGS

Aspects of the present disclosure are best understood from the following detailed description when read with the accompanying drawings. It is noted that various features may not be drawn to scale, and the dimensions of the various features may be arbitrarily increased or reduced for clarity of discussion.

FIG. 1 is a cross-section of a package structure in accordance with some embodiments of the present disclosure;

FIG. 2 is a schematic perspective view of a portion of a package structure in accordance with some embodiments of the present disclosure;

FIG. 3A1 is a top view of a package structure in accordance with some embodiments of the present disclosure;

FIG. 3A2 is a schematic perspective view of a portion of a package structure in accordance with some embodiments of the present disclosure;

FIG. 3B1 is a top view of a package structure in accordance with some embodiments of the present disclosure;

FIG. 3B2 is a schematic perspective view of a portion of a package structure in accordance with some embodiments of the present disclosure;

FIG. 3C1 is a top view of a package structure in accordance with some embodiments of the present disclosure;

FIG. 3C2 is a schematic perspective view of a portion of a package structure in accordance with some embodiments of the present disclosure;

FIG. 3C3 is a schematic perspective view of a portion of a package structure in accordance with some embodiments of the present disclosure;

FIG. 4A is a cross-section of a portion of a package structure in accordance with some embodiments of the present disclosure;

FIG. 4B is a cross-section of a portion of a package structure in accordance with some embodiments of the present disclosure;

FIG. 4C is a cross-section of a portion of a package structure in accordance with some embodiments of the present disclosure;

FIG. 5A is a cross-section of a portion of a package structure in accordance with some embodiments of the present disclosure;

FIG. 5B is a cross-section of a portion of a package structure in accordance with some embodiments of the present disclosure;

FIG. 5C is a cross-section of a portion of a package structure in accordance with some embodiments of the present disclosure;

FIG. 5D is a cross-section of a portion of a package structure in accordance with some embodiments of the present disclosure;

FIG. 6 is a cross-section of a package structure in accordance with some embodiments of the present disclosure;

FIG. 7A1, FIG. 7A2, FIG. 7B, FIG. 7C, FIG. 7D, FIG. 7E, FIG. 7F, FIG. 7G, FIG. 7H, FIG. 7I, and FIG. 7J illustrate various operations in a method of manufacturing a package structure in accordance with some embodiments of the present disclosure;

FIG. 8A, FIG. 8B, FIG. 8C, and FIG. 8D illustrate various operations in a method of manufacturing a package structure in accordance with some embodiments of the present disclosure; and

FIG. 9A and FIG. 9B illustrate various operations in a method of manufacturing a package structure in accordance with some embodiments of the present disclosure.

Common reference numerals are used throughout the drawings and the detailed description to indicate the same or similar elements. The present disclosure will be more apparent from the following detailed description taken in conjunction with the accompanying drawings.

### DETAILED DESCRIPTION

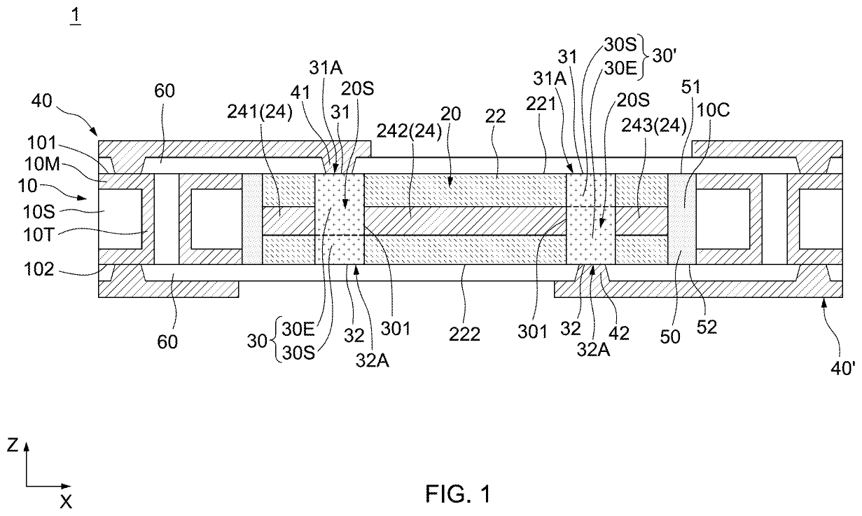

FIG. 1 is a cross-section of a package structure 1 in accordance with some embodiments of the present disclosure. The package structure 1 includes a substrate 10, an electronic component 20, connection elements 30 and 30′, conductive patterns 40 and 40′, a dielectric structure 50, and insulation layers 60.

The substrate 10 may include, for example, a printed circuit board, such as a paper-based copper foil laminate, a composite copper foil laminate, or a polymer-impregnated glass-fiber-based copper foil laminate. The substrate 10 may include an interconnection structure, such as a redistribution layer (RDL) including one or more conductive traces and one or more conductive through vias and/or a grounding element. In some embodiments, the substrate 10 includes a ceramic material or a metal plate. In some embodiments, the substrate 10 may include an organic substrate or a leadframe. In some embodiments, the substrate 10 may include a two-layer substrate (e.g., a core substrate) which includes a core layer and a conductive material and/or structure disposed on an upper surface and a bottom surface of the core layer. The conductive material and/or structure may include a plurality of traces. In some embodiments, the substrate 10 may include a core-less substrate or other types of substrates. In some embodiments, the substrate 10 may include a package substrate with circuitry therein.

The substrate 10 may include a surface 101 and a surface 102 opposite to the surface 101. In some embodiments, the substrate 10 defines one or more cavities 10C. In some embodiments, the cavity 10C penetrates the substrate 10 between the surface 101 and the surface 102. In some embodiments, the substrate 10 includes a supporting portion 10S (or a core layer) defining the one or more cavities 10C for accommodating the electronic component 20. In some embodiments, the supporting portion 10S (or the core layer) may be made of or include a material that is relatively firm or having a relatively high hardness. By way of example, the material of the supporting portion 10S may include polypropylene (PP), a resin material (e.g., epoxy-based resin), or other suitable dielectric or insulative materials. The substrate 10 may include a plurality of conductive structures 10T such as conductive vias extending from the surface 101 to the surface 102 of the substrate 10 to electrically connect electronic components and/or conductive features disposed on the surface 101 and the surface 102. For example, the conductive structure 10T may include copper or other suitable conductive materials. In some embodiments, the conductive structure 10T includes a multi-layered structure including a conductive liner and an insulative material filled within or surrounded by the conductive liner. The conductive liner may include copper. The substrate 10 may further include conductive layers 10M on an upper surface and a bottom surface of the supporting portion 10S (or the core layer). In some embodiments, the conductive layer 10M is electrically connected to the conductive structure 10T.

The electronic component 20 may be disposed in the substrate 10. In some embodiments, the electronic component 20 is disposed within the cavity 10C of the substrate 10. The thickness of the electronic component 20 may be less than or equal to that of the substrate 10 such that the installation of the electronic component 20 does not increase the overall thickness of the package substrate 1. The electronic component 20 may include a passive component such as an inductor. In some embodiments, the electronic component 20 includes a magnetic layer 22 (also referred to as “a magnetic body”) and one or more conductive wires 24. In some embodiments, the magnetic layer 22 encapsulates the conductive wire 24. In some embodiments, the conductive wire 24 is embedded in the magnetic layer 22. In some embodiments, the electronic component 20 includes one or more through holes 20S penetrating the magnetic layer 22. In some embodiments, the one or more through holes 20S penetrate the conductive wire 24. In some embodiments, the electronic component 20 has a structure which is substantially symmetrical with a horizontal plane (e.g., a horizontal plane substantially parallel to the surface 101 of the substrate 10). For example, the structure including the magnetic layer 22 and the conductive wire 24 as a whole can be substantially symmetrical with a horizontal plane.

In some embodiments, the magnetic layer 22 has a surface 221 and a surface 222 opposite to the surface 221. In some embodiments, the magnetic layer 22 is electrically insulative. In some embodiments, the electronic component 20 is an inductor, and the magnetic layer 22 being electrically insulative can prevent malfunction of the inductor. In some embodiments, the magnetic layer 22 may include ferrite or other suitable insulative magnetic materials. For example, the material of the magnetic layer 22 may include a compound of iron oxide and other components including one of magnesium (Mg), aluminum (Al), barium (Ba), manganese (Mn), copper (Cu), nickel (Ni), cobalt (Co) or the like. In some embodiments, the conductive wire 24 includes a plurality of portions (e.g., portions 241, 242, and 243). In some embodiments, the connection element 30 is between the portion 241 and the portion 242, and the connection element 30′ is between the portion 242 and the portion 243. In some embodiments, two ends of the conductive wire 24 may be substantially coplanar with end surfaces of the magnetic layer 22 or covered by the magnetic layer 22. In some embodiments, the conductive wire 24 may include a metal wire such as a copper wire.

The connection element 30 may penetrate the electronic component 20 and contact the conductive wire 24. In some embodiments, the connection element 30 penetrates and contacts the magnetic layer 22 and the conductive wire 24. In some embodiments, the connection element 30 is in the through hole 20S of the electronic component 20 and contacts the conductive wire 24. In some embodiments, the portion 241 of the conductive wire 24 and the portion 242 of the conductive wire 24 are divided by the connection element 30. In some embodiments, the portion 241 of the conductive wire 24 and the portion 242 of the conductive wire 24 are electrically connected by the connection element 30. In some embodiments, the connection element 30 is free of an interface between different materials. In some embodiments, the connection element 30 is free of multiple portions of different or heterogeneous materials as viewed in a direction (e.g., a Z-axis) perpendicular to the surface 101. In some embodiments, the connection element 30 is integrally formed. In some embodiments, a lateral surface 301 of the connection element 30 is covered by the conductive wire 24. In some embodiments, the lateral surface 301 of the connection element 30 is surrounded by the conductive wire 24. In some embodiments, a modulus of the connection element 30 is greater than or exceeds a modulus of the conductive wire 24. In some embodiments, the modulus of the connection element 30 substantially equals a modulus of the magnetic layer 22. In some embodiments, a CTE of the connection element 30 substantially equals a CTE of the magnetic layer 22. In some embodiments, the connection element 30 includes a conductive gel or a conductive paste. In some embodiments, the connection element 30 includes a resin layer and a conductive material dispersed in the resin layer.

In some embodiments, the connection element 30 includes a contact 31A exposed by the surface 221 of the magnetic layer 22 and a contact 32A exposed by the surface 222 of the magnetic layer 22. In some embodiments, the contact 31A and the contact 32A of the connection element 30 overlap in a direction (e.g., a Z-axis) substantially perpendicular to the surface 221 of the magnetic layer 22. In some embodiments, the contact 31A includes a surface 31 substantially coplanar with the surface 221 of the magnetic layer 22. In some embodiments, the contact 32A includes a surface 32 substantially coplanar with the surface 222 of the magnetic layer 22.

In some embodiments, the connection element 30 includes an electrical connection portion 30E and a support portion 30S at substantially the same potential. In some embodiments, the electrical connection portion 30E and the support portion 30S are equipotential. In some embodiments, the electrical connection portion 30E and the support portion 30S have substantially the same electric potential. In some embodiments, the electrical connection portion 30E directly contacts or connects to the support portion 30S. In some embodiments, the electrical connection portion 30E and the support portion 30S of the connection element 30 are integrally formed. In some embodiments, the electrical connection portion 30E and the support portion 30S of the connection element 30 are free of an interface therebetween. In some embodiments, the electrical connection portion 30E is configured to electrically connect to the substrate 10, and the support portion 30S is configured to support the electrical connection portion 30E. In some embodiments, the electrical connection portion 30E of the connection element 30 has a surface (e.g., the surface 31) exposed by the surface 221 of the magnetic layer 22. In some embodiments, the exposed surface of the electrical connection portion 30E (e.g., the surface 31 of the connection element 30) electrically connects to the substrate 10. In some embodiments, the support portion 30S of the connection element 30 has a surface (e.g., the surface 32) exposed by the surface 222 of the magnetic layer 22. In some embodiments, the electrical connection portion 30E and the support portion 30S are located on opposite sides of the conductive wire 24 in a cross-sectional view. In some embodiments, the exposed surface of the support portion 30S (e.g., the surface 32 of the connection element 30) is free from contacting a conductive feature (e.g., a conductive layer, a conductive pattern, or the like). According to some embodiments of the present disclosure, with the design of the electrical connection portion 30E and the support portion 30S, warpage can be effectively reduced.

The connection element 30′ may penetrate the electronic component 20 and contact the conductive wire 24. In some embodiments, the connection element 30′ penetrates and contacts the magnetic layer 22 and the conductive wire 24. In some embodiments, the connection element 30′ is in the through hole 20S of the electronic component 20 and contacts the conductive wire 24. In some embodiments, the portion 242 of the conductive wire 24 and the portion 243 of the conductive wire 24 are divided by the connection element 30′. In some embodiments, the portion 242 of the conductive wire 24 and the portion 243 of the conductive wire 24 are electrically connected by the connection element 30′. In some embodiments, the connection element 30′ is free of an interface between different materials. In some embodiments, the connection element 30′ is integrally formed. In some embodiments, a lateral surface 301 of the connection element 30′ is covered by the conductive wire 24. In some embodiments, the lateral surface 301 of the connection element 30′ is surrounded by the conductive wire 24. In some embodiments, a modulus of the connection element 30′ is greater than or exceeds a modulus of the conductive wire 24. In some embodiments, the modulus of the connection element 30′ substantially equals a modulus of the magnetic layer 22. In some embodiments, a CTE of the connection element 30′ substantially equals a CTE of the magnetic layer 22. In some embodiments, the connection element 30′ includes a conductive gel or a conductive paste. In some embodiments, the connection element 30′ includes a resin layer and a conductive material dispersed therein.

In some embodiments, the connection element 30′ includes a contact 31A exposed by the surface 221 of the magnetic layer 22 and a contact 32A exposed by the surface 222 of the magnetic layer 22. In some embodiments, the contact 31A and the contact 32A of the connection element 30′ overlap in a direction (e.g., a Z-axis) substantially perpendicular to the surface 221 of the magnetic layer 22. In some embodiments, the contact 31A includes a surface 31 substantially coplanar with the surface 221 of the magnetic layer 22. In some embodiments, the contact 32A includes a surface 32 substantially coplanar with the surface 222 of the magnetic layer 22.

In some embodiments, the connection element 30′ includes an electrical connection portion 30E and a support portion 30S at substantially the same potential. In some embodiments, the electrical connection portion 30E directly contacts or connects to the support portion 30S. In some embodiments, the electrical connection portion 30E and the support portion 30S of the connection element 30′ are integrally formed. In some embodiments, the electrical connection portion 30E and the support portion 30S of the connection element 30′ are free of an interface therebetween. In some embodiments, the electrical connection portion 30E is configured to electrically connect to the substrate 10, and the support portion 30S is configured to support the electrical connection portion 30E. In some embodiments, the electrical connection portion 30E of the connection element 30′ has a surface (e.g., the surface 32) exposed by the surface 222 of the magnetic layer 22. In some embodiments, the exposed surface of the electrical connection portion 30E (e.g., the surface 32 of the connection element 30′) electrically connects to the substrate 10. In some embodiments, the support portion 30S of the connection element 30′ has a surface (e.g., the surface 31) exposed by the surface 221 of the magnetic layer 22. In some embodiments, the exposed surface of the support portion 30S (e.g., the surface 31 of the connection element 30′) is free from contacting a conductive feature (e.g., a conductive layer, a conductive pattern, or the like).

The conductive pattern 40 may be on the surface 101 of the substrate 10, and the conductive pattern 40′ may be on the surface 102 of the substrate 10. In some embodiments, the conductive pattern 40 is electrically connected to the connection element 30, and the conductive pattern 40′ is electrically connected to the connection element 30′. In some embodiments, the conductive pattern 40 includes a conductive via 41, and the conductive pattern 40′ includes a conductive via 42.

In some embodiments, the conductive via 41 is electrically connected to the connection element 30, and a contact interface (e.g., the surface 31 of the connection element 30) between the conductive via 41 and the connection element 30 substantially aligns with the surface 221 of the electronic component 20. In some embodiments, the conductive via 41 electrically connects the substrate 10 to the connection element 30 through the conductive layer 10M. In some embodiments, the contact interface (e.g., the surface 31 of the connection element 30) between the conductive via 41 and the connection element 30 is exposed by the surface 221 of the electronic component 20, and the connection element 30 further has an end surface (e.g., the surface 32 of the connection element 30) exposed by the surface 222 of the electronic component 20 and free from contacting a conductive feature.

In some embodiments, the conductive via 42 is electrically connected to the connection element 30′, and a contact interface (e.g., the surface 32 of the connection element 30′) between the conductive via 42 and the connection element 30′ substantially aligns with the surface 222 of the electronic component 20. In some embodiments, the conductive via 42 electrically connects the substrate 10 to the connection element 30′ through the conductive layer 10M. In some embodiments, the contact interface (e.g., the surface 32 of the connection element 30′) between the conductive via 42 and the connection element 30′ is exposed by the surface 222 of the electronic component 20, and the connection element 30′ further has an end surface (e.g., the surface 31 of the connection element 30′) exposed by the surface 221 of the electronic component 20 and free from contacting a conductive feature.

The dielectric structure 50 may be filled in the cavity 10C of the substrate 10. In some embodiments, the dielectric structure 50 is spaced apart from the connection element 30. In some embodiments, the dielectric structure 50 is spaced apart from the connection element 30′. In some embodiments, a surface 51 (also referred to as “a top surface”) of the dielectric structure 50 substantially aligns with the contact interface (e.g., the surface 31 of the connection element 30) between the conductive via 41 and the connection element 30. In some embodiments, a surface 52 (also referred to as “a bottom surface”) of the dielectric structure 50 substantially aligns with the contact interface (e.g., the surface 32 of the connection element 30′) between the conductive via 42 and the connection element 30′. In some embodiments, the dielectric structure 50 is configured to fix the electronic component 20 in the cavity 10C. The dielectric structure 50 may include a resin layer. In some embodiments, the dielectric structure 50 includes a thermoplastic material such as acrylonitrile butadiene styrene (ABS). While the dielectric structure 50 may have a relatively large CTE and thus tend to expand and contract when subjected to a temperature change, and such volume change may result in warpage of the package structure 1. In some embodiments, a modulus of the connection element 30 is greater than a modulus of the dielectric structure 50 and substantially equals a modulus of the magnetic layer 22, and thus the aforementioned warpage can be mitigated or prevented.

The insulation layers 60 may be on the surfaces 101 and 102 of the substrate 10. In some embodiments, the insulation layer 60 covers the end surface (e.g., the surface 32 of the connection element 30) exposed by the surface 222 of the electronic component 20. In some embodiments, the insulation layer 60 covers the end surface (e.g., the surface 31 of the connection element 30′) exposed by the surface 221 of the electronic component 20. In some embodiments, the insulation layers 60 may include polypropylene (PP), a resin material (e.g., epoxy-based resin), or other suitable dielectric or insulative materials.

In some cases where an inductor is electrically connected to a substrate through a conductive via which directly connects the conductive wire of the inductor to a conductive pattern over the inductor, the conductive via may have a relatively high aspect ratio, and the operation for forming the hole (also referred to as “blind hole”) for the conductive via suffers from low yield due to the difficulty of aligning the hole to the exact predetermined position of the embedded conductive wire of the inductor.

In contrast, according to some embodiments of the present disclosure, with the design of the connection element 30 penetrating and contacting the magnetic layer 22 and the conductive wire 24 of the electronic component 20 (e.g., the inductor), the aspect ratio of the conductive via 41 which electrically connects the substrate 10 to the electronic component 20 through the connection element 30 can be significantly reduced, which is advantageous to simplifying the process and increasing yield. Moreover, with the reduced thickness of the conductive via 41, the conduction path between the conductive pattern 40 and the electronic component 20 is reduced, and thus signal loss is reduced accordingly. As well, the size and/or arrangement of the connection element 30 may vary according to actual applications (e.g., according to the size and/or the position of the conductive via 41), and thus the chances of failing to align the conductive via 41 to the connection element 30 or failing to electrically connect the conductive via 41 to the electronic component 20 can be significantly reduced, and therefore yield can be increased.

In addition, according to some embodiments of the present disclosure, a modulus of the connection element 30 is greater than or exceeds a modulus of the conductive wire 24, and thus warpage of the overall structure can be prevented.

Furthermore, according to some embodiments of the present disclosure, the connection element 30 penetrates the electronic component 20 between the surface 221 and the surface 222, thus the conductive vias 41 and 42 may be formed on opposite sides of the electronic component 20 according to the actual applications of the circuit designs rather than on only one side of the electronic component 20, and therefore the routing flexibility of conductive patterns can be increased.

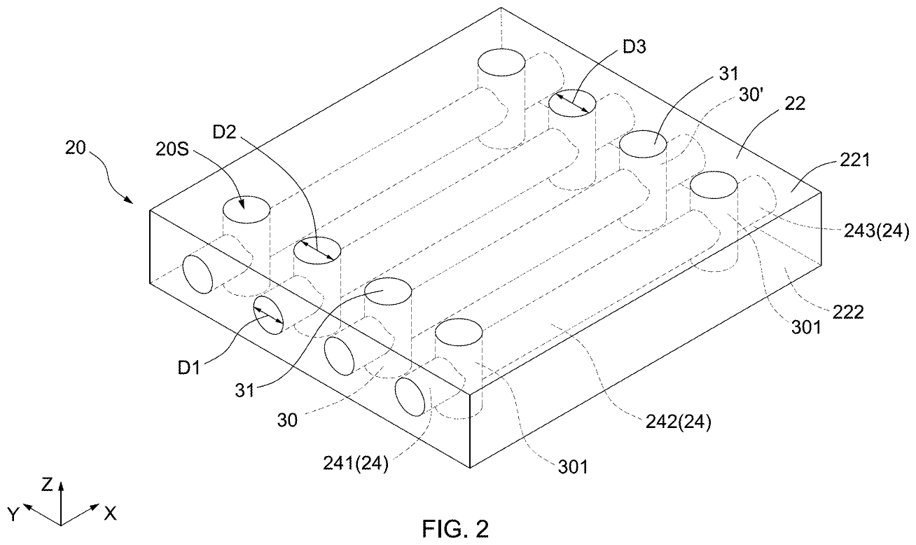

FIG. 2 is a schematic perspective view of a portion of a package structure 1 in accordance with some embodiments of the present disclosure. In some embodiments, FIG. 2 is a schematic perspective view of the electronic component 20 and the connection elements 30 and 30′ in FIG. 1.

In some embodiments, the electronic component 20 includes a plurality of conductive wires 24 embedded in the magnetic layer 22, and the electronic component 20 may include a plurality of inductors embedded in the magnetic layer 22. In some embodiments, the conductive wires 24 are substantially straight parallel wires extending along a direction (e.g., Y-axis). In some embodiments, a width D1 (e.g., a diameter) of the conductive wire 24 is equal to or less than a width D2 (e.g., a diameter) of the connection element 30 in a direction (e.g., Y-axis) at an angle with another direction (e.g., X-axis) of the conductive wire 24. In some embodiments, the width D1 (e.g., the diameter) of the conductive wire 24 is equal to or less than a width D3 (e.g., a diameter) of the connection element 30′ in a direction (e.g., Y-axis) at an angle with another direction (e.g., X-axis) of the conductive wire 24.

In some embodiments, a portion of a peripheral surface of the conductive wire 24 is covered by the connection element 30. In some embodiments, a portion of a peripheral surface of the conductive wire 24 is surrounded by the connection element 30. In some embodiments, a portion of a peripheral surface of the conductive wire 24 is covered by the connection element 30′. In some embodiments, a portion of a peripheral surface of the conductive wire 24 is surrounded by the connection element 30′.

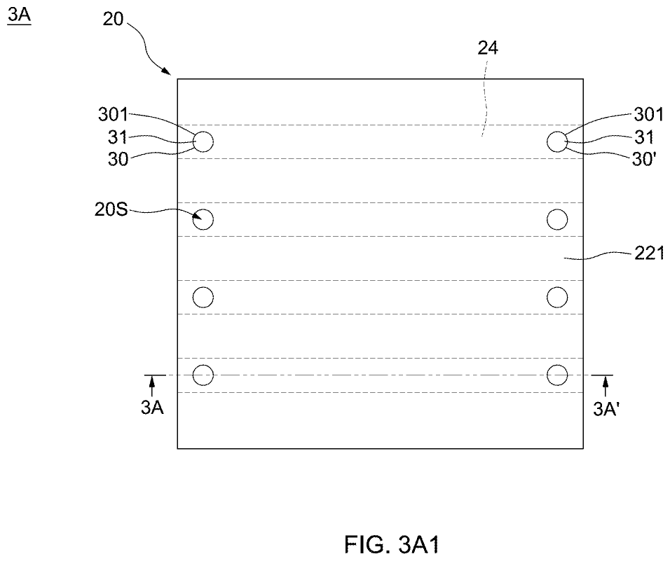

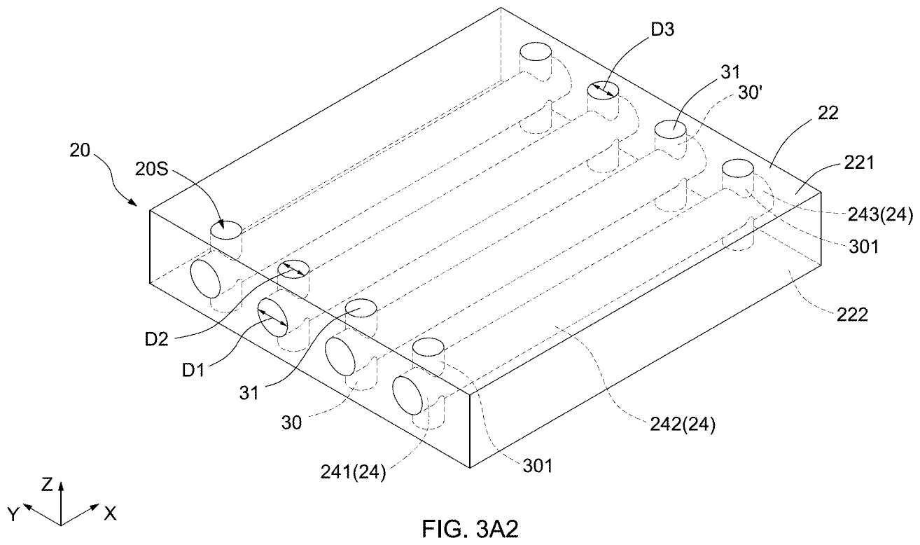

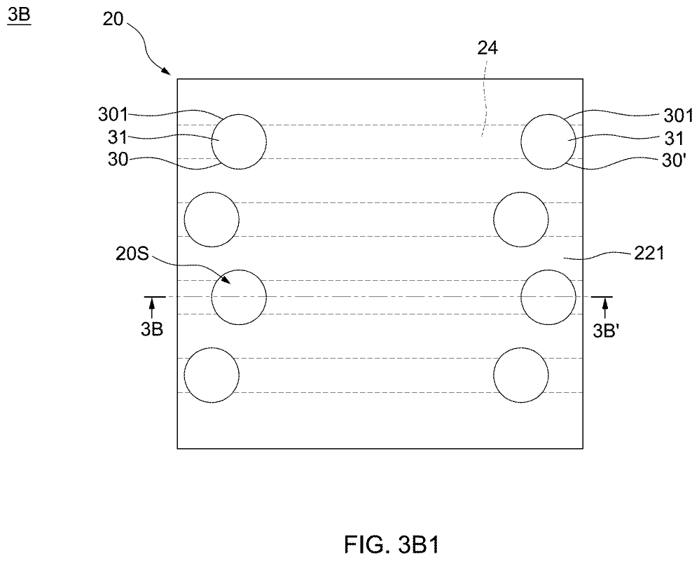

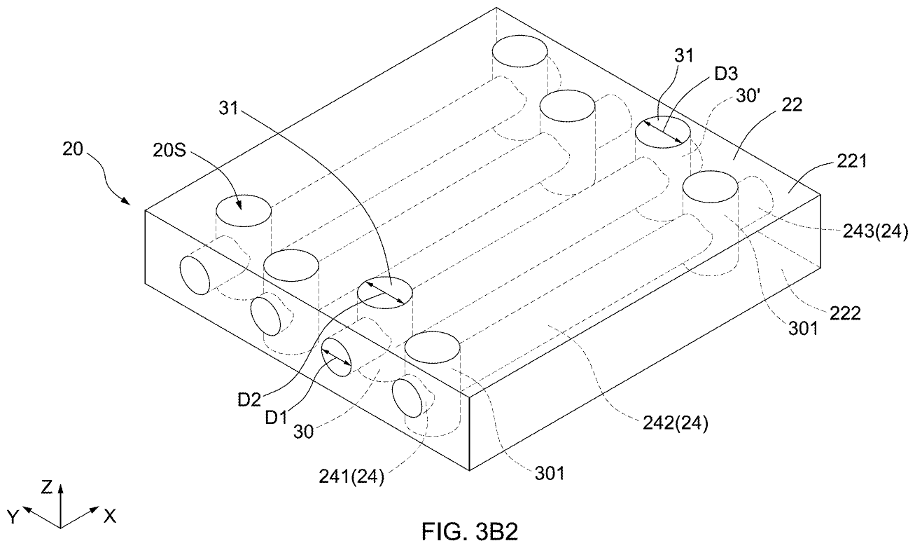

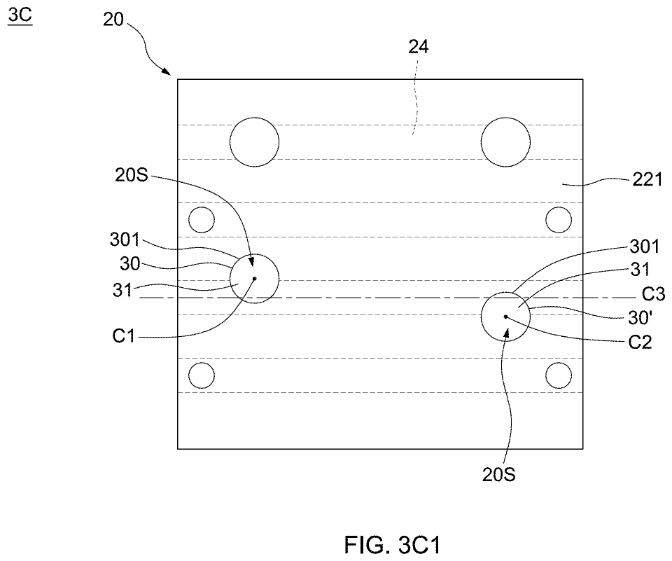

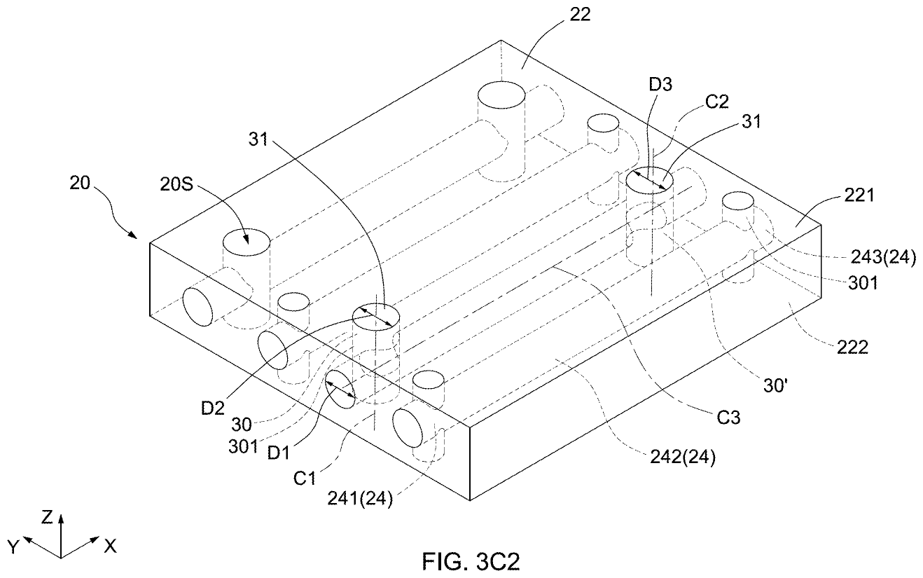

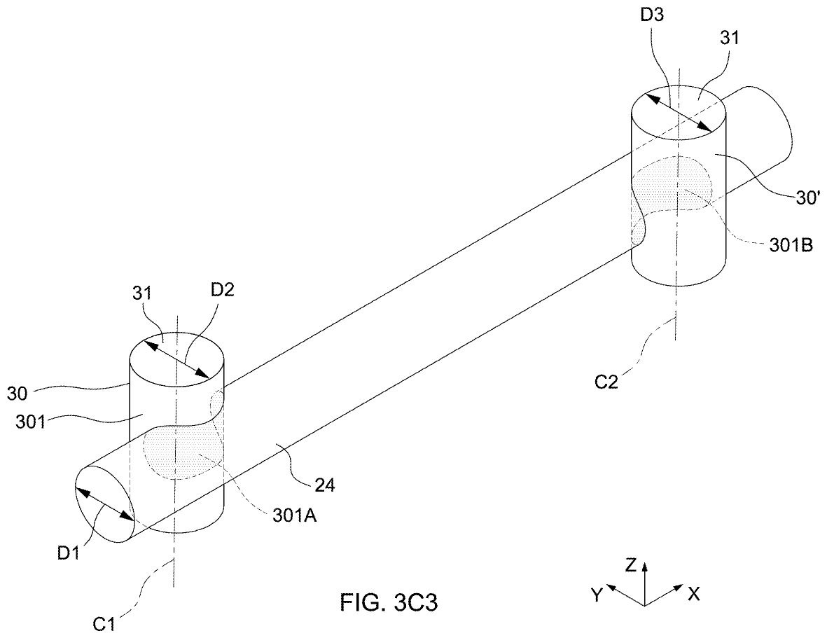

FIG. 3A1 is a top view of a package structure 3A in accordance with some embodiments of the present disclosure, and FIG. 3A2 is a schematic perspective view of a portion of a package structure 3A in accordance with some embodiments of the present disclosure. In some embodiments, FIG. 3A1 is a top view of the electronic component 20 and the connection elements 30 and 30′, and FIG. 3A2 is a schematic perspective view of the electronic component 20 and the connection elements 30 and 30′ in FIG. 3A1. In some embodiments, the package structure 3A may have a cross-section (e.g., along the line 3A-3A′) as illustrated in FIG. 1.

In some embodiments, portions of lateral surfaces 301 of the connection elements 30 and 30′ are covered by the conductive wire 24. In some embodiments, portions of lateral surfaces 301 of the connection elements 30 and 30′ are surrounded by the conductive wire 24. In some embodiments, a width D1 (e.g., a diameter) of the conductive wire 24 is greater than or exceeds a width D2 (e.g., a diameter) of the connection element 30 in a direction (e.g., the Y-axis) at an angle with another direction (e.g., the X-axis) of the conductive wire 24. In some embodiments, the width D1 (e.g., the diameter) of the conductive wire 24 is greater than or exceeds a width D3 (e.g., a diameter) of the connection element 30′ in a direction (e.g., the Y-axis) at an angle with another direction (e.g., the X-axis) of the conductive wire 24.

FIG. 3B1 is a top view of a package structure 3B in accordance with some embodiments of the present disclosure, and FIG. 3B2 is a schematic perspective view of a portion of a package structure 3B in accordance with some embodiments of the present disclosure. In some embodiments, FIG. 3B1 is a top view of the electronic component 20 and the connection elements 30 and 30′, and FIG. 3B2 is a schematic perspective view of the electronic component 20 and the connection elements 30 and 30′ in FIG. 3B1. In some embodiments, the package structure 3B may have a cross-section (e.g., along the line 3B-3B′) as illustrated in FIG. 1.

In some embodiments, portions of a peripheral surface of the conductive wire 24 are covered by the connection elements 30 and 30′. In some embodiments, portions of a peripheral surface of the conductive wire 24 are surrounded by the connection elements 30 and 30′. In some embodiments, a width D1 (e.g., a diameter) of the conductive wire 24 is less than a width D2 (e.g., a diameter) of the connection element 30 in a direction (e.g., the Y-axis) at an angle with another direction (e.g., the X-axis) of the conductive wire 24. In some embodiments, the width D1 (e.g., the diameter) of the conductive wire 24 is less than a width D3 (e.g., a diameter) of the connection element 30′ in a direction (e.g., the Y-axis) at an angle with another direction (e.g., the X-axis) of the conductive wire 24. In some embodiments, the connection elements 30 are staggered along an orientation (e.g., the Y-axis) at an angle with another orientation (e.g., the X-axis) of the conductive wire 24. In some embodiments, the connection elements 30′ are staggered along an orientation (e.g., the Y-axis) at an angle with another orientation (e.g., the X-axis) of the conductive wire 24.

FIG. 3C1 is a top view of a package structure 3C in accordance with some embodiments of the present disclosure, FIG. 3C2 is a schematic perspective view of a portion of a package structure 3C in accordance with some embodiments of the present disclosure, and FIG. 3C3 is a schematic perspective view of a portion of a package structure in accordance with some embodiments of the present disclosure. In some embodiments, FIG. 3C1 is a top view of the electronic component 20 and the connection elements 30 and 30′, FIG. 3C2 is a schematic perspective view of the electronic component 20 and the connection elements 30 and 30′ in FIG. 3C1, and FIG. 3C3 is a schematic perspective view of a portion of a conductive wire 24 contacting a portion of the connection element 30 and a portion of the connection element 30′. In some embodiments, the package structure 3C may have a cross-section as illustrated in FIG. 1.

In some embodiments, a central line (e.g., central lines C1 and C2) of the through hole 20S is free from crossing a central line C3 of the conductive wire 24. In some embodiments, a central line (e.g., the central line C1) of the connection element 30 is free from crossing the central line C3 of the conductive wire 24. In some embodiments, a central line (e.g., the central line C2) of the connection element 30′ is free from crossing the central line C3 of the conductive wire 24. In some embodiments, a portion of the connection element 30 is embedded in the conductive wire 24. In some embodiments, the connection element 30 covers a portion of a peripheral region of the conductive wire 24. In some embodiments, the conductive wire 24 covers a portion of a circumference of the connection element 30. In some embodiments, the conductive wire 24 defines a recess to accommodate and contact a portion of the connection element 30. In some embodiments, the portion of the connection element 30 in the recess has a surface 301A (also referred to as “a contact surface”) that contacts the conductive wire 24. In some embodiments, a portion of the connection element 30′ is embedded in the conductive wire 24. In some embodiments, the connection element 30′ covers a portion of a peripheral region of the conductive wire 24. In some embodiments, the conductive wire 24 covers a portion of a circumference of the connection element 30′. In some embodiments, the conductive wire 24 defines a recess to accommodate and contact a portion of the connection element 30′. In some embodiments, the portion of the connection element 30′ in the recess has a surface 301B (also referred to as “a contact surface”) that contacts the conductive wire 24.

In some embodiments, at least two of the through holes 20S have different widths. In some embodiments, at least two of the connection elements 30 and 30′ have different widths. The positions and sizes (e.g., the widths) of the connection elements 30 and 30′ may vary according to actual applications.

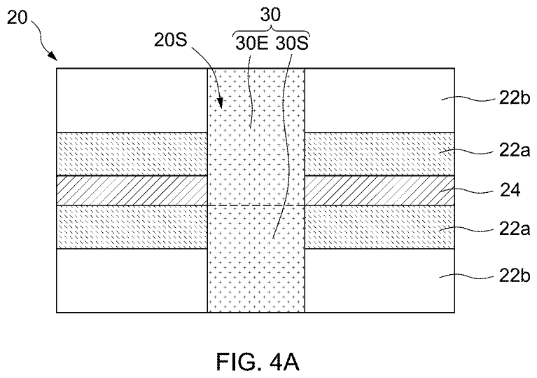

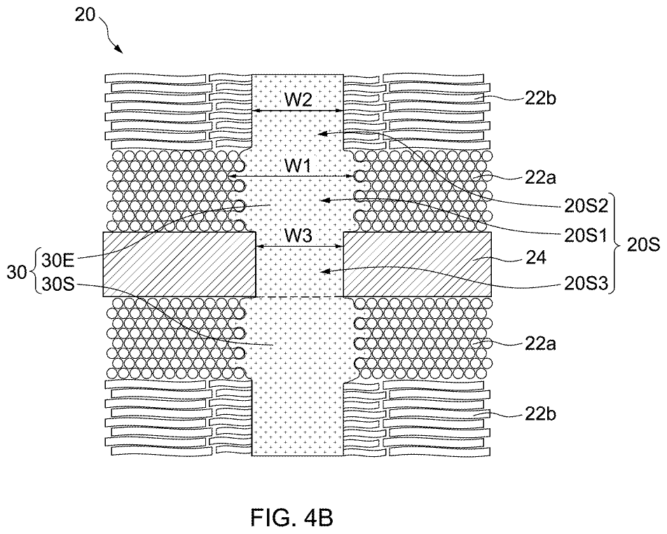

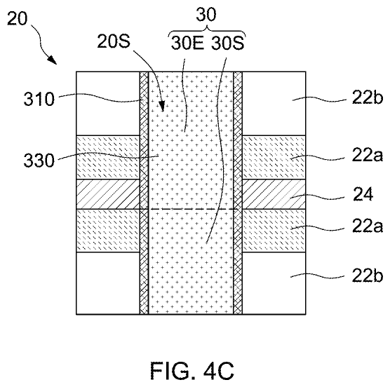

FIG. 4A is a cross-section of a portion of a package structure in accordance with some embodiments of the present disclosure. In some embodiments, FIG. 4A is a cross-section of the electronic component 20 and the connection element 30. In some embodiments, the package structure 1 in FIG. 1 may include a structure illustrated in FIG. 4A.

In some embodiments, the magnetic layer 22 includes layers (or sub-layers) 22a and 22b. In some embodiments, the layers 22a and 22b includes different materials. In some embodiments, the layer 22a is on the conductive wire 24, and the layer 22b is on the layer 22a. In some embodiments, the layer 22a encapsulates or covers the conductive wire 24, and the layer 22b encapsulates or covers the layer 22a. In some embodiments, the layer 22a surrounds the conductive wire 24, and the layer 22b surrounds the layer 22a.

FIG. 4B is a cross-section of a portion of a package structure in accordance with some embodiments of the present disclosure. In some embodiments, FIG. 4B is a cross-section of the electronic component 20 and the connection element 30. In some embodiments, the package structure 1 in FIG. 1 may include a structure illustrated in FIG. 4B.

In some embodiments, the through hole 20S includes a plurality of portions (e.g., portions 20S1, 20S2, and 20S3) having different widths. The portion 20S1 may be connected to the portion 20S2 and the portion 20S3. In some embodiments, the portion 20S1 has a width W1 greater than a width W2 of the portion 20S2. In some embodiments, the portion 20S3 has a width W3 less than the width W1 of the portion 20S1. In some embodiments, the portion 20S1 is defined by the layer 22a, and the portion 20S2 is defined by the layer 22b. In some embodiments, the portion 20S3 is defined by the conductive wire 24. In some embodiments, sidewalls of the portions 20S1, 20S2, and 20S3 of the through hole 20S have different surface roughness. In some embodiments, the connection element 30 includes a plurality of portions each in a corresponding portion of the through hole 20S. In some embodiments, the connection element 30 includes a portion defied by the layer 22a, a portion defined by the layer 22b, and a portion defined by the conductive wire 24, and at least two of the portions of the connection element 30 have different widths (e.g., the widths W1, W2, and W3).

In some embodiments, the layers 22a and 22b include magnetic materials having different shapes. In some embodiments, the layer 22a includes magnetic particles, and the layer 22b includes magnetic flakes. The magnetic particles in the layer 22a may be spherical. In some embodiments, a surface roughness of the sidewall of the portion 20S1 defined by the layer 22a is greater than or exceeds a surface roughness of the sidewall of the portion 20S2 defined by the layer 22b. In some embodiments, a surface roughness of the sidewall of the portion 20S3 defined by the conductive wire 24 is less than the surface roughness of the sidewalls of the portions 20S1 and 20S2. In some embodiments, the sidewall of the portion 20S1 has a microstructure bearing defects from detached magnetic particles. In some embodiments, the sidewall of the portion 20S1 has a wavy shape or morphology. In some embodiments, the sidewall of the portion 20S1 has curved surfaces. The curved surfaces may be formed from exposed surfaces of the magnetic particles. In some embodiments, the sidewall of the portion 20S2 has a relatively flat surface morphology. The relatively flat surface of the sidewall of the portion 20S2 may be formed from cut-off edges of the magnetic flakes. In some embodiments, the sidewall of the portion 20S3 has a relatively flat surface morphology, which may be formed from cut-off edges of the conductive wire 24. In some embodiments, the connection element 30 has a morphology conformal with the sidewalls of the portions 20S1, 20S2, and 20S3 of the through hole 20S. In some embodiments, the connection element 30 includes a portion having a surface including protrusions that are conformal with the curved surfaces of the sidewall of the portion 20S1. In some embodiments, the connection element 30 includes a portion having a relatively flat surface that is conformal with the relatively flat surface of the sidewall of the portion 20S2. In some embodiments, the connection element 30 includes a portion having a relatively flat surface that is conformal with the relatively flat surface of the sidewall of the portion 20S3. In some embodiments, the connection element 30 is or includes a conductive gel or a conductive paste. In some embodiments, the connection element 30′ (not shown in FIG. 4B) may have a structure and/or a material the same as or similar to that of the connection element 30 in FIG. 4B.

FIG. 4C is a cross-section of a portion of a package structure in accordance with some embodiments of the present disclosure. In some embodiments, FIG. 4C is a cross-section of the electronic component 20 and the connection element 30. In some embodiments, the package structure 1 in FIG. 1 may include a structure illustrated in FIG. 4C.

In some embodiments, the connection element 30 includes layers 310 and 330. In some embodiments, the connection element 30 includes a conductive gel or a conductive paste, and the layers 310 and 330 are gel layers or paste layers. In some embodiments, the layer 310 contacts an inner wall of the electronic component 20, and the layer 330 is on the layer 310. In some embodiments, the layer 310 contacts an inner wall of the through hole 20S, and the layer 330 is filled in the through hole 20S. In some embodiments, the layer 310 surrounds the layer 330. In some embodiments, the layer 330 is filled within the layer 310. In some embodiments, the layer 330 has a viscosity higher than that of the layer 310.

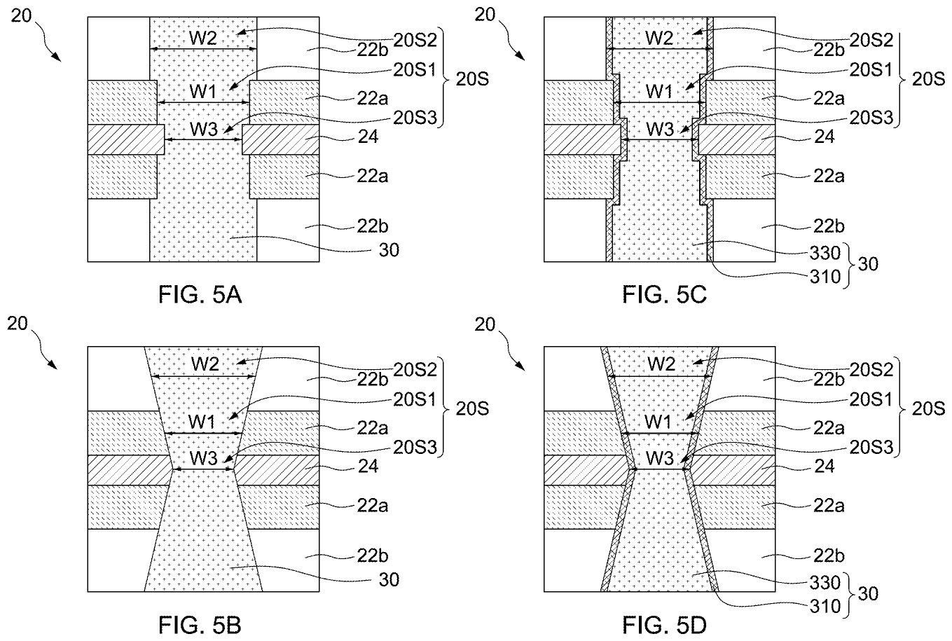

FIG. 5A is a cross-section of a portion of a package structure in accordance with some embodiments of the present disclosure. In some embodiments, FIG. 5A is a cross-section of the electronic component 20 and the connection element 30. In some embodiments, the package structure 1 in FIG. 1 may include a structure illustrated in FIG. 5A.

In some embodiments, an inner wall of the through hole 20S has a stepped profile. In some embodiments, the width W2 of the portion 20S2 is greater than or exceeds the width W1 of the portion 20S1, and the width W1 of the portion 20S1 is greater than or exceeds the width W3 of the portion 30S3. In some embodiments, the connection element 30 includes a stepped structure. In some embodiments, a portion of the conductive wire 24 protrudes into the connection element 30 (or the conductive gel or the conductive paste).

FIG. 5B is a cross-section of a portion of a package structure in accordance with some embodiments of the present disclosure. In some embodiments, FIG. 5B is a cross-section of the electronic component 20 and the connection element 30. In some embodiments, the package structure 1 in FIG. 1 may include a structure illustrated in FIG. 5B.

In some embodiments, the through hole 20S has a cross-section having an X shape or an hourglass shape. In some embodiments, the connection element 30 has a cross-section having an X shape or an hourglass shape. In some embodiments, the width W2 of the portion 20S2 is greater than or exceeds the width W1 of the portion 20S1, and the width W1 of the portion 20S1 is greater than or exceeds the width W3 of the portion 30S3. In some embodiments, the width W2 of the portion 20S2 decreases toward the portion 20S1, and the width W1 of the portion 20S1 decreases toward the portion 20S3.

FIG. 5C is a cross-section of a portion of a package structure in accordance with some embodiments of the present disclosure. In some embodiments, FIG. 5C is a cross-section of the electronic component 20 and the connection element 30. In some embodiments, the package structure 1 in FIG. 1 may include a structure illustrated in FIG. 5C. The structure shown in FIG. 5C is similar to that shown in FIG. 5A, differing in that the connection element 30 in FIG. 5C includes layers 310 and 330. In some embodiments, the layer 310 is conformal with an inner wall of the through hole 20S.

FIG. 5D is a cross-section of a portion of a package structure in accordance with some embodiments of the present disclosure. In some embodiments, FIG. 5D is a cross-section of the electronic component 20 and the connection element 30. In some embodiments, the package structure 1 in FIG. 1 may include a structure illustrated in FIG. 5D. The structure shown in FIG. 5D is similar to that shown in FIG. 5B, differing in that the connection element 30 in FIG. 5D includes layers 310 and 330. In some embodiments, the layer 310 is conformal with an inner wall of the through hole 20S.

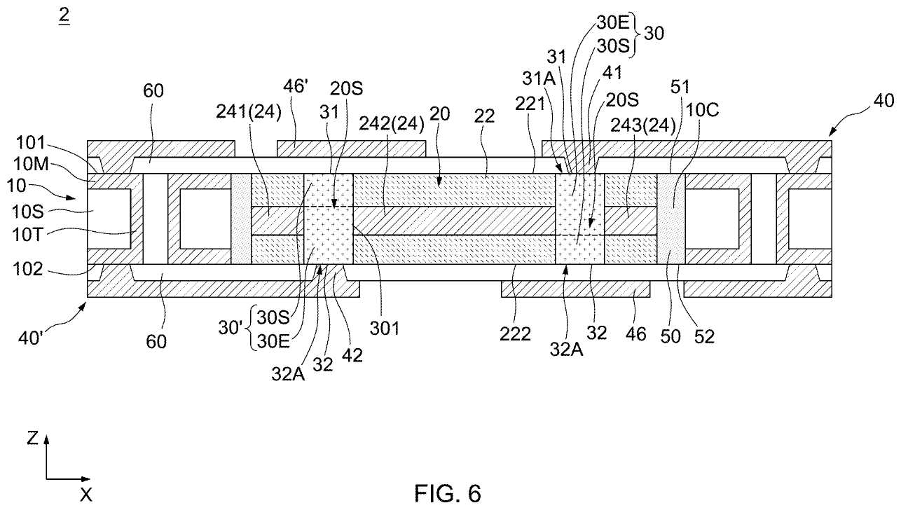

FIG. 6 is a cross-section of a package structure 2 in accordance with some embodiments of the present disclosure. The package structure 2 is similar to the package structure 1 in FIG. 1, with differences therebetween as follows.

In some embodiments, the package structure 2 further includes one or more stress balance conductive patterns (e.g., stress balance conductive patterns 46 and 46′). In some embodiments, the stress balance conductive pattern 46 is disposed over or adjacent to the end surface (e.g., the surface 32) of the connection element 30. In some embodiments, the stress balance conductive pattern 46 and the conductive via 41 overlap in a direction (e.g., a Z-axis) substantially perpendicular to the surface 221 of the magnetic layer 22. In some embodiments, the stress balance conductive pattern 46′ is disposed over or adjacent to the end surface (e.g., the surface 31) of the connection element 30′. In some embodiments, the stress balance conductive pattern 46′ and the conductive via 42 overlap in a direction (e.g., a Z-axis) substantially perpendicular to the surface 221 of the magnetic layer 22. In some embodiments, the stress balance conductive patterns 46 and 46′ are electrically isolated from the substrate 10 and the electronic component 20. In some embodiments, the stress balance conductive patterns 46 and 46′ include dummy metal patterns. In some embodiments, the stress balance conductive patterns 46 and 46′ are configured to generate a sum (e.g., the amount, the area, or the like) of the conductive materials (e.g., Cu) of the conductive patterns (e.g., the conductive patterns 40 and 46′) over the surface 101 of the substrate 10 that is substantially close to a sum (e.g., the amount, the area, or the like) of the conductive materials (e.g., Cu) of the conductive patterns (e.g., the conductive patterns 40′ and 46) over the surface 102 of the substrate 10. In some embodiments, the stress balance conductive patterns 46 and 46′ are configured to adjust and/or balance the stress on opposite sides (e.g., the surfaces 101 and 102) of the substrate 10, such that warpage can be mitigated or prevented. For example, the arrangements (e.g., the patterns and/or the positions) of the stress balance conductive patterns 46 and 46′ may vary according to actual arrangements of the conductive patterns 40 and 40′ so as to balance the stress on opposite sides (e.g., the surfaces 101 and 102) of the substrate 10 and reduce warpage.

According to some embodiments of the present disclosure, with the design of the stress balance conductive patterns 46 and 46′, the unbalanced stress caused by the conductive patterns 40 and 40′ can be compensated, and thus warpage can be reduced.

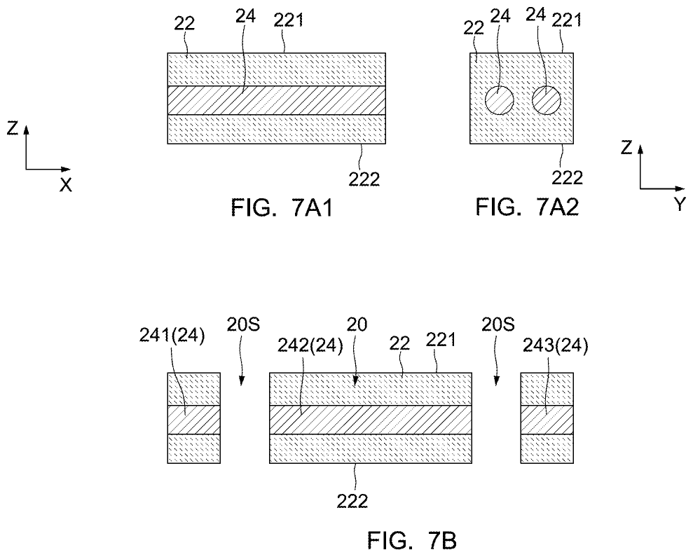

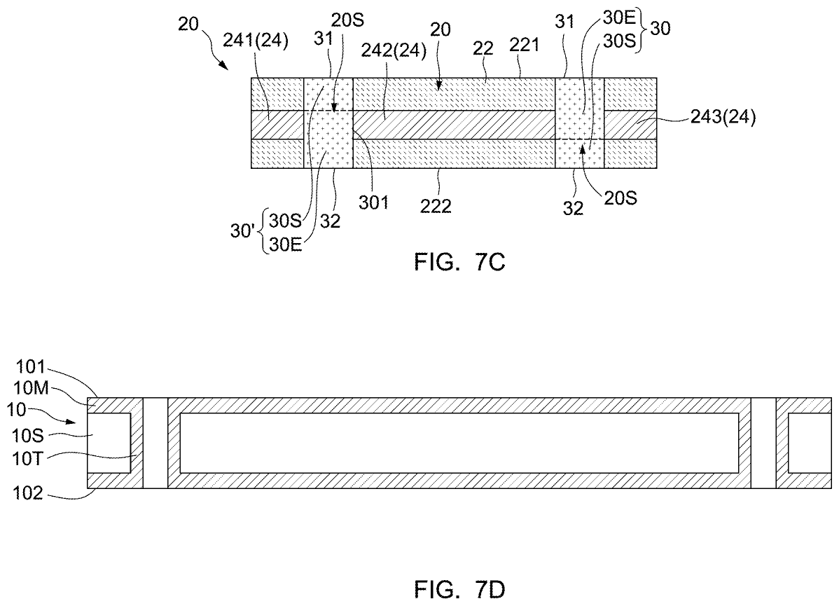

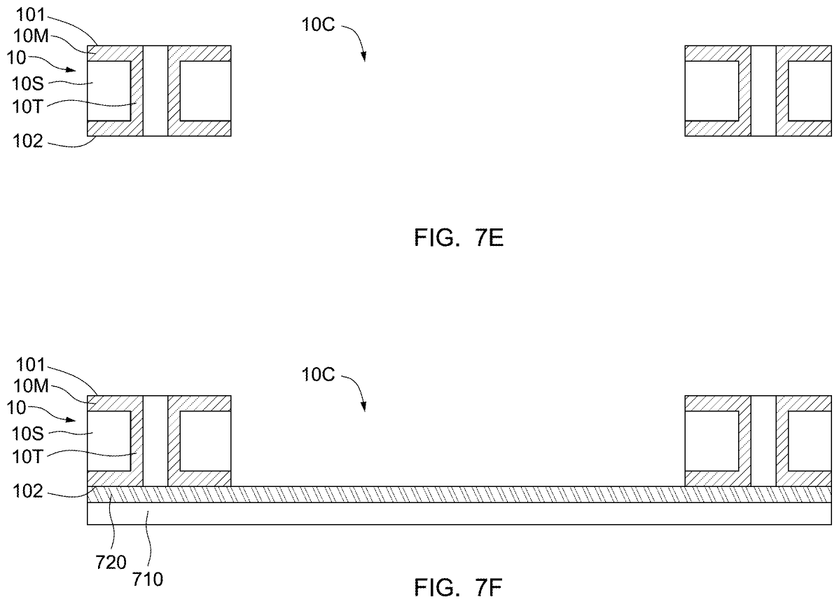

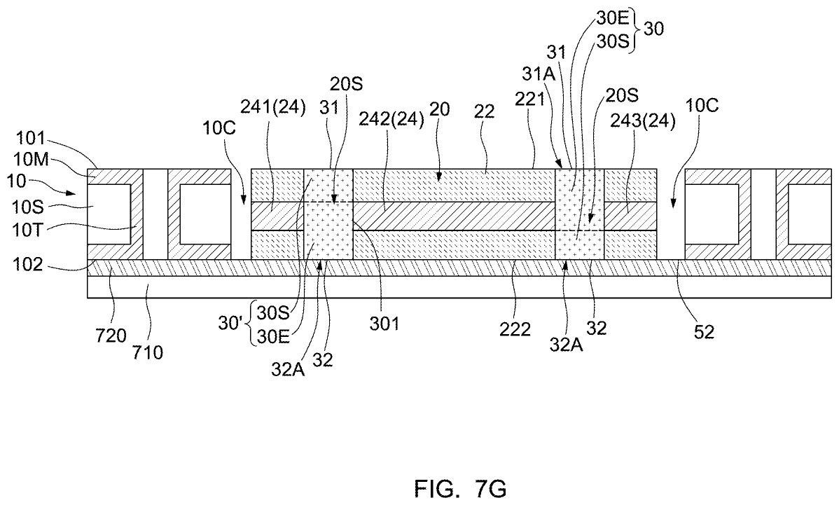

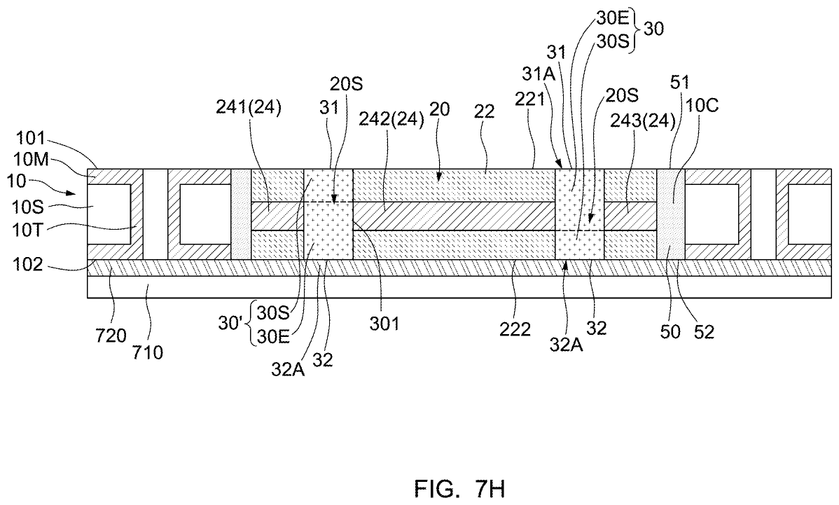

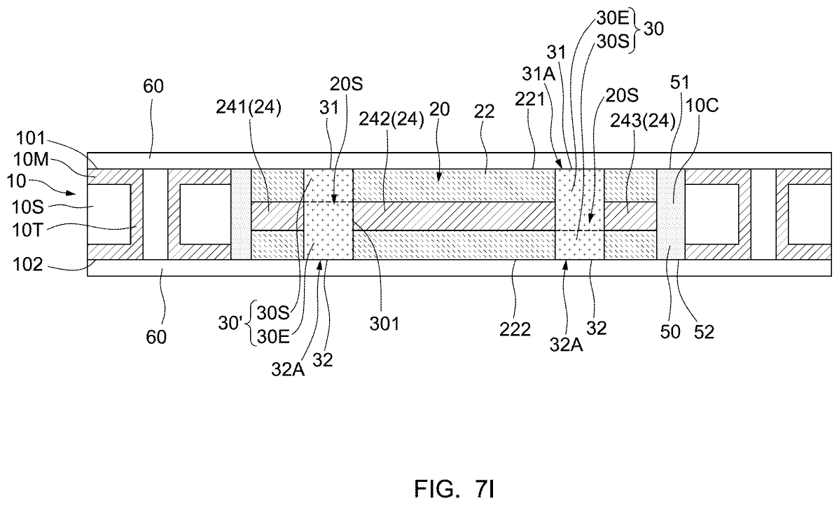

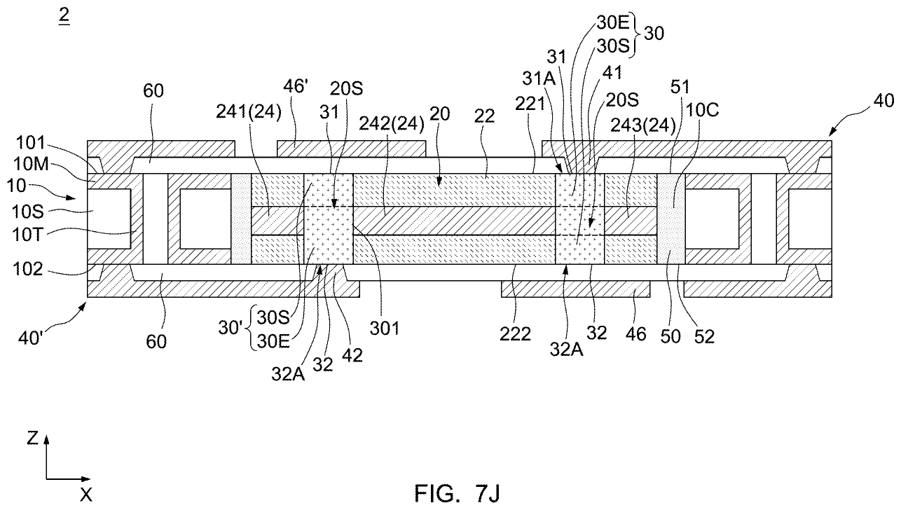

FIG. 7A1, FIG. 7A2, FIG. 7B, FIG. 7C, FIG. 7D, FIG. 7E, FIG. 7F, FIG. 7G, FIG. 7H, FIG. 7I, and FIG. 7J illustrate various operations in a method of manufacturing a package structure 2 in accordance with some embodiments of the present disclosure.

Referring to FIG. 7A1 and FIG. 7A2, which are cross-sections from different perspectives, an electronic component including a magnetic layer 22 and conductive wires 24 encapsulated by the magnetic layer 22 may be formed. In some embodiments, FIG. 7A1 is a cross-section along a Y-axis, and FIG. 7A2 along an X-axis.

Referring to FIG. 7B, through holes 20S may be formed to penetrate the magnetic layer 22 and the conductive wires 24. In some embodiments, the through holes 20S may be formed by a mechanical drilling operation.

Referring to FIG. 7C, connection elements 30 and 30′ may be formed in the through holes 20S. In some embodiments, a conductive gel or a conductive paste is filled in the through holes 20S, and then a curing operation is performed on the conductive gel or the conductive paste to form the connection elements 30 and 30′. As such, an electronic component 20 with the connection elements 30 and 30′ penetrating the electronic component 20 is formed.

Referring to FIG. 7D, a substrate 10 may be provided. In some embodiments, the substrate 10 includes a supporting portion 10S (or a core layer), conductive layers 10M, and conductive structures 10T. In some embodiments, the substrate 10 is a core substrate.

Referring to FIG. 7E, a cavity 10C may be formed in the substrate 10. In some embodiments, the cavity 10C penetrates the substrate 10.

Referring to FIG. 7F, the substrate 10 may be adhered to a carrier 710 through an adhesive layer 720 to seal the cavity 10C. In some embodiments, the carrier 710 serves to provide rigid support for the adhesive layer 720. In some embodiments, the adhesive layer 720 includes a tape. In some embodiments, a thickness of the carrier 710 is equal to or less than a thickness of the magnetic layer 22.

Referring to FIG. 7G, the electronic component 20 with the connection elements 30 and 30′ illustrated in FIG. 7C may be disposed in the cavity 10C and fixed with the adhesive layer 720.

Referring to FIG. 7H, a dielectric structure 50 may be formed in the cavity 10C. In some embodiments, the dielectric structure 50 may be flowable (e.g., fluid), and the dielectric structure 50 may fill the cavity 10C and between the edges of the electronic component 20 and the supporting portion 10S of the substrate 10. The dielectric structure 50 may be thermally and/or optically cured to solidify. In some embodiments, the dielectric structure 50 is configured to fix the electronic component 20 in the cavity 10C. In some embodiments, a grinding operation may be performed to remove excess materials of the dielectric structure 50 over the surface 101 of the substrate 10 and the surface 221 of the electronic component 20 to expose the conductive layers 10M and the connection elements 30 and 30′. In some embodiments, the grinding operation is configured to provide the connection element 30 with a flat or planarized surface (e.g., the surface 31) for improving electrical connection between the connection element 30 and the conductive via 41 which will be formed subsequently.

Referring to FIG. 7I, an insulation layer 60 may be formed on the surface 101 of the substrate 10, the carrier 710 and the adhesive layer 720 may be removed, and then an insulation layer 60 may be formed on the surface 102 of the substrate 10. In some embodiments, the insulation layers 60 may be formed by lamination.

Referring to FIG. 7J, portions of the insulation layers 60 may be removed to form vias exposing portions of the surfaces 101 and 102 of the substrate 10, and conductive patterns 40 and 40′ may be formed on the insulation layers 60. The vias may be formed by one or more laser drilling operations. In some embodiments, conductive materials may be formed on the surfaces 101 and 102 and in the vias of the insulation layers 60 by one or more plating operations to form the conductive patterns 40 and 40′ and the conductive vias 41 and 42. The insulation layers 60 may protect the magnetic layer 22 from being damaged by the chemical solution used in the plating operation. In some embodiments, one or more patterning operations may be performed on the conductive materials to form the conductive patterns 40 and 40′ and the stress balance conductive patterns 46 and 46′. In some embodiments, the conductive pattern 40 and the stress balance conductive pattern 46 are formed by the same patterning operation, and the conductive pattern 40′ and the stress balance conductive pattern 46′ are formed by the same patterning operation. As such, the package structure 2 illustrated in FIG. 6 is formed.

In some other embodiments, one or more patterning operations may be performed on the conductive materials to form the conductive patterns 40 and 40′ without forming the stress balance conductive patterns 46 and 46′. As such, the package structure 1 illustrated in FIG. 1 may be formed.

According to some embodiments of the present disclosure, the through hole 20S for forming the connection element 30 is formed by a mechanical drilling operation rather than a laser drilling operation, such that re-melting of the magnetic layer 22 due to the relatively high temperature from the laser operation is prevented, and thus formation of undesired irregular morphology of the inner wall of the through hole 20S can be prevented. Therefore, it is advantageous to the formation of the connection element 30 in the through hole 20S. As well, the through hole 20S penetrates the electronic component 20, thus debris formed during the mechanical drilling operation can be discharged out the through hole 20S easily, and therefore formation of defects on the connection element 30 which could have been caused by debris in the through hole 20S can be effectively prevented.

In addition, a via or a through hole formed by a laser drilling operation usually has a tapered shape with the tapered end at the bottom contacting the target feature and a relatively large opening at top, which may lead to a relatively large contact area, with the relatively large aspect ratio of the via or the through hole formed by a laser drilling operation is disadvantageous to the plating operation for forming a conductive layer within the via or the through hole. In contrast, according to some embodiments of the present disclosure, with formation of the through hole 20S by mechanical drilling, the aforesaid issues can be mitigated or prevented, and thus yield can be increased.

Moreover, according to some embodiments of the present disclosure, the connection element 30 is formed by filling a conductive gel or a conductive paste in the through hole 20S rather than plating a metal material in the through hole 20S, whereby the magnetic layer 22 can be protected from damage or etching by the plating chemical solution. In addition, according to some embodiments of the present disclosure, a modulus of the connection element 30 is greater than or exceeds a modulus of the conductive wire 24, and thus warpage of the overall structure can be prevented.

Furthermore, laser drilling may be unable to form a relatively flat or planarized surface for electrical contact. For example, the conductive wire exposed by a laser-drilled via may still have a curved surface rather than a flat surface. In contrast, according to some embodiments of the present disclosure, with formation of the through hole 20S by mechanical drilling, portions of the conductive wire 24 that are exposed to the through hole 20S to contact the connection element 30 have relatively flat and large contact surfaces, and the connection element 30 is formed by filling a conductive gel or a conductive paste rather than plating a conductive material, providing good electrical connection between the conductive wire 24 and the conductive via 41 through the connection element 30.

Furthermore, according to some embodiments of the present disclosure, the electrical connection between the electronic component 20 and the substrate 10 can be achieved by simply performing mechanical drilling and conductive gel/paste filling without modifying a large number of steps of the existing process, the manufacturing process is simplified, and the time required is reduced.

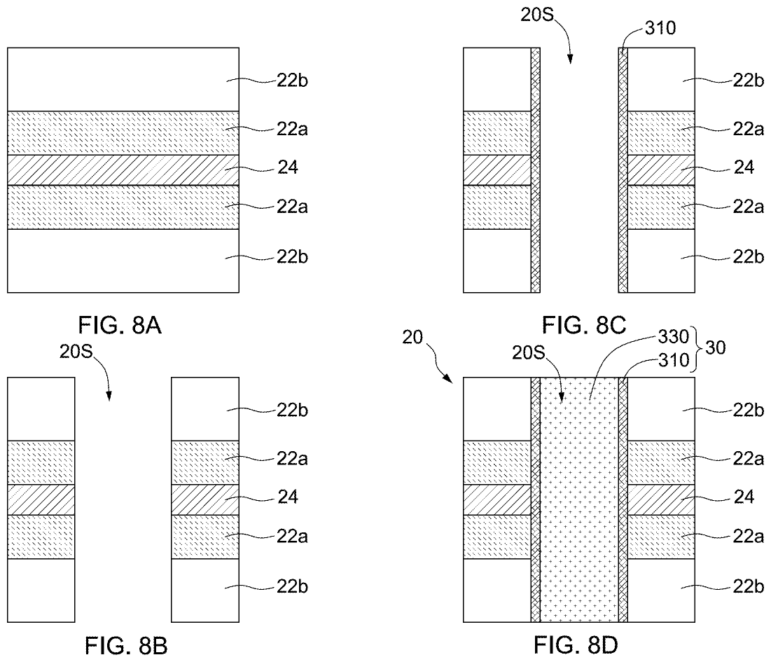

FIG. 8A, FIG. 8B, FIG. 8C, and FIG. 8D illustrate various operations in a method of manufacturing a package structure in accordance with some embodiments of the present disclosure.

Referring to FIG. 8A, an electronic component including a magnetic layer 22 and a conductive wire 24 encapsulated by the magnetic layer 22 may be formed. In some embodiments, the magnetic layer 22 includes layers (or sub-layers) 22a and 22b.

Referring to FIG. 8B, a through hole 20S may be formed to penetrate the layers 22a and 22b of the magnetic layer 22 and the conductive wire 24. In some embodiments, the through holes 20S may be formed by a mechanical drilling operation.

Referring to FIG. 8C, a layer 310 may be formed on an inner wall of the through hole 20S, and a pre-curing operation may be performed on the layer 310. In some embodiments, the layer 310 may be formed by forming a gel material or a paste material on the inner wall of the through hole 20S followed by the pre-curing operation.

Referring to FIG. 8D, a layer 330 may be formed on the layer 310 to fill the through hole 20S. In some embodiments, the layer 330 may be formed by forming a gel material or a paste material having a viscosity higher than that of the material of the layer 310. In some embodiments, a curing operation is performed on the layers 310 and 330 to fully solidify the gel materials or the paste materials of the layers 310 and 330 to form the connection element 30. With the material of the layer 330 having a viscosity higher than that of the layer 310, overflow or leakage of the material of the layer 330 in the curing operation can be effectively prevented. As such, an electronic component 20 with the connection element 30 penetrating the electronic component 20 is formed.

Next, operations similar to those illustrated in FIGS. 7D-7J may be performed to form a package structure including the electronic component 20 and the connection element 30 having structures illustrated in FIG. 8D (or in FIG. 4C).

According to some embodiments of the present disclosure, the connection element 30 is formed by forming the through hole 20S by mechanical rather than laser drilling, and by filling a conductive gel or a conductive paste in the through hole 20S rather than plating a conductive material in the through hole 20S, the magnetic layer 22 can be protected from damage or etching by the plating chemical solution. Therefore, delamination between the layers 22a and 22b of the magnetic layer 22 and/or the delamination between a plated conductive layer and the magnetic layer 22 can be further prevented, and thus yield is increased.

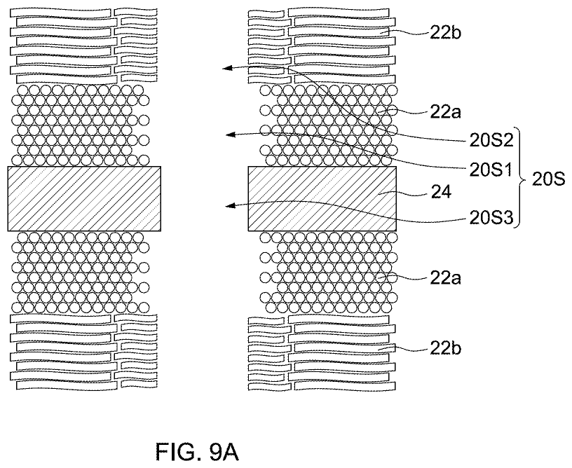

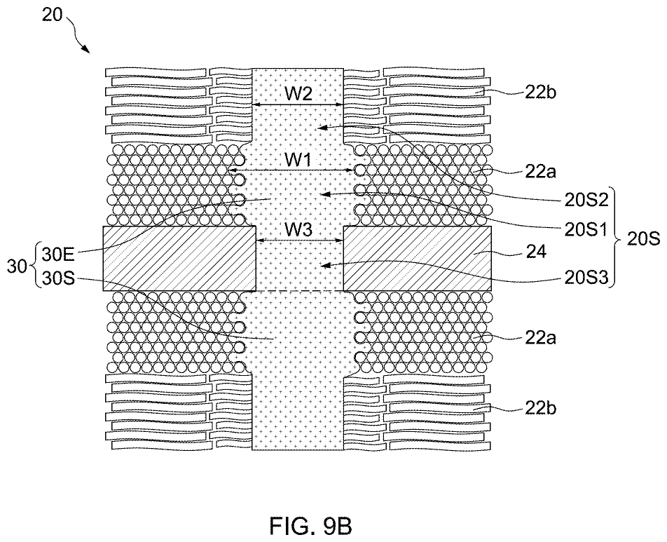

FIG. 9A and FIG. 9B illustrate various operations in a method of manufacturing a package structure in accordance with some embodiments of the present disclosure.

Referring to FIG. 9A, an electronic component including a magnetic layer 22 and a conductive wire 24 encapsulated by the magnetic layer 22 may be formed, and a through hole 20S may be formed to penetrate the magnetic layer 22 and the conductive wire 24. In some embodiments, the through holes 20S may be formed by a mechanical drilling operation. In some embodiments, the magnetic layer 22 includes a layer 22a including magnetic particles and a layer 22b including magnetic flakes. The through hole 20S may be formed to penetrate the layers 22a and 22b of the magnetic layer 22 and the conductive wire 24.

In some embodiments, the through hole 20S includes a plurality of portions (e.g., portions 20S1, 20S2, and 20S3) having different widths and defined by different layers (e.g., the layer 22a, the layer 22b, and the conductive wire 24). In some embodiments, the sidewall of the portion 20S1 has a microstructure of defects resulting from discarded magnetic particles (e.g., some magnetic particles falling off during the mechanical drilling operation for forming the through hole 20S).

Referring to FIG. 9B, a gel material or a paste material may be formed to fill in the through hole 20S to form a connection element 30. In some embodiments, the gel material or the paste material may be flowable to fill in the small cavities of the microstructure of the sidewall of the portion 20S1. In some embodiments, a curing operation is then performed on the gel material or the paste material to form the connection element 30. In some embodiments, the as-formed (or fully solidified) connection element 30 has a morphology conformal with the sidewalls of the portions 20S1, 20S2, and 20S3 of the through hole 20S. As such, an electronic component 20 with the connection element 30 penetrating the electronic component 20 is formed.

Next, operations similar to those illustrated in FIGS. 7D-7J may be performed to form a package structure including the electronic component 20 and the connection element 30 having structures illustrated in FIG. 9B (or in FIG. 4B). In some other embodiments, the operations illustrated in FIGS. 7A1-7J, 8A-8D, and 9A-9B may be independently used for forming a package structure having one or more electronic component 20 (e.g., inductors) having various shapes different from that of the electronic component 20 illustrated herein. For example, the operations illustrated in FIGS. 7A1-7J, 8A-8D, and/or 9A-9B may be used for forming package structures having spiral inductors.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of said numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” or “about” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” parallel can refer to a range of angular variation relative to 0° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Two surfaces can be deemed to be coplanar or substantially coplanar if a displacement between the two surfaces is no greater than 5 μm, no greater than 2 μm, no greater than or no greater than 0.5 μm.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

As used herein, the singular terms “a,” “an,” and “the” may include plural referents unless the context clearly dictates otherwise. In the description of some embodiments, a component provided “on” or “over” another component can encompass cases where the former component is directly on (e.g., in physical contact with) the latter component, as well as cases where one or more intervening components are located between the former component and the latter component.

While the present disclosure has been described and illustrated with reference to specific embodiments thereof, these descriptions and illustrations do not limit the present disclosure. It can be clearly understood by those skilled in the art that various changes may be made, and equivalent components may be substituted within the embodiments without departing from the true spirit and scope of the present disclosure as defined by the appended claims. The illustrations may not necessarily be drawn to scale. There may be distinctions between the artistic renditions in the present disclosure and the actual apparatus, due to variables in manufacturing processes and the like. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it can be understood that these operations may be combined, sub-divided, or re-ordered to form an equivalent method without departing from the teachings of the present disclosure. Therefore, unless specifically indicated herein, the order and grouping of the operations are not limitations of the present disclosure.

What is claimed is:

1. A package structure, comprising:
an electronic component comprising a conductive wire and a magnetic layer encapsulating the conductive wire; and
a connection element penetrating and contacting the magnetic layer and the conductive wire.

2. The package structure as claimed in claim 1, wherein the magnetic layer has a first surface and a second surface opposite to the first surface, and the connection element comprises a first contact exposed by the first surface of the magnetic layer and a second contact exposed by the second surface of the magnetic layer.

3. The package structure as claimed in claim 2, wherein the first contact and the second contact overlap in a direction substantially perpendicular to the first surface of the magnetic layer.

4. The package structure as claimed in claim 1, wherein the connection element comprises an electrical connection portion and a support portion at substantially the same potential.

5. The package structure as claimed in claim 4, wherein the electrical connection portion is configured to electrically connect to a substrate, and the support portion is configured to support the electrical connection portion.

6. The package structure as claimed in claim 4, wherein the electrical connection portion and the support portion are located on opposite sides of the conductive wire in a cross-sectional view.

7. The package structure as claimed in claim 1, wherein the conductive wire comprises a first portion and a second portion electrically connected to each other by the connection element.

8. The package structure as claimed in claim 1, wherein a lateral surface of the connection element is covered by the conductive wire.

9. The package structure as claimed in claim 1, wherein the electronic component has a structure which is substantially symmetrical with a horizontal plane.

10. The package structure as claimed in claim 9, wherein a modulus of the connection element is greater than a modulus of the conductive wire.

11. A package structure, comprising:
an electronic component comprising a magnetic body and a conductive wire embedded in the magnetic body; and
a conductive gel penetrating the magnetic body and contacting the conductive wire.

12. The package structure as claimed in claim 11, wherein the magnetic body comprises:
a first layer encapsulating the conductive wire; and
a second layer on the first layer, wherein the first layer and the second layer comprise different materials.

13. The package structure as claimed in claim 12, wherein the conductive gel comprises a first portion defined by the first layer and a second portion defined by the second layer, and the first portion and the second portion have different widths.

14. The package structure as claimed in claim 11, wherein a portion of the conductive wire protrudes into the conductive gel.

15. The package structure as claimed in claim 11, wherein a central line of the conductive gel is free from crossing a central line of the conductive wire.

16. The package structure as claimed in claim 11, wherein the conductive gel comprises:
a first gel layer contacting an inner wall of the electronic component; and
a second gel layer on the first gel layer and having a viscosity higher than that of the first gel layer.

17. A package structure, comprising:
an inductor comprising a conductive wire;
a first connection element penetrating the inductor and contacting the conductive wire; and
a first conductive via electrically connected to the first connection element, wherein a contact interface between the first conductive via and the first connection element substantially aligns with a first surface of the inductor.

18. The package structure as claimed in claim 17, further comprising a substrate defining a cavity, wherein the inductor is disposed within the cavity, and the first conductive via electrically connects the substrate to the first connection element.

19. The package structure as claimed in claim 18, further comprising a dielectric structure filled in the cavity and spaced apart from the first connection element.

20. The package structure as claimed in claim 19, wherein a top surface of the dielectric structure substantially aligns with the contact interface between the first conductive via and the first connection element.
